(19) United States
(12) Patent Application Publication
(10) Pub. No.: US 2011/0137909 A1
(43) Pub. Date: Jun. 9, 2011

(54) LOCATION INDEPENDENT EXECUTION OF USER INTERFACE OPERATIONS

(75) Inventors: Jochen Guertler, Karlsruhe (DE); Yahali Sherman, Tel Aviv (IL); Ariel Tammam, Ramat Gan (IL); Ran Gross, Rosh-Haain (IL)

(73) Assignee: SAP AG, Walldorf (DE)

(21) Appl. No.: 12/632,253

(22) Filed: Dec. 7, 2009

(51) Int. Cl. G06F 15/16; G06F 17/30

(52) U.S. Cl. 707/741; 709/203; 709/248; 707/E17.017

(57) ABSTRACT

This disclosure relates to systems, methods, and software that involve location-independent execution of user interface operations. This execution can include identifying a user interaction through a client-side user interface that is communicably coupled with a server-side computer. It is then dynamically determined whether to process the identified user interaction on the client-side or the server-side. If the user interaction is to be processed on the client-side, then a client-side action handler is invoked. If the user interaction is to be processed on the server-side, then it is requested that a server-side action handler process the interaction.

### TECHNICAL FIELD

This disclosure relates to systems, methods, and software that involve location-independent execution of user interface operations. For example, the present disclosure provides a framework that facilitates switching between client-side or server-side operation processing, often in real-time.

### BACKGROUND

Graphical user interfaces (GUIs) allow a computer user to control a computer system and to input and modify data on a computer system through a display interface. Some applications implement UIs in a client program running in a client server architecture, such as a Web browser. The UIs typically include controls operable by a user to interact with the applications. Controls can include buttons, menus, pull-down menus, dialog boxes, scroll bars, and any other controls that enable the user to view application data, invoke application functionality, and otherwise interact with an application. Each control has an associated control state, and the application has an associated UI state. The control states and the UI state can change based on user interaction. Navigation in a GUI typically involves moving a pointing device such as a mouse to an active element and activating the element by clicking on the element. Alternatively, various keystrokes from a keyboard device (e.g., pressing the “tab” key) allow a user to traverse the GUI elements.

Developing User Interface (or web) application frameworks often involves a debate as to whether operations or user interactions (e.g. the user clicks on a link or button to trigger an operation) should be handled at the client-side (perhaps using a Java Script framework running within the browser) or on the server-side (perhaps using a Java framework running on an web application server). A visual representation of the application can be generated by rendering the UI state of the application in a client program running in a client server architecture, e.g., the Web browser.

### SUMMARY

An aspect of the present disclosure is directed to location-independent execution of user interface operations or interactions. For example, a computer program product for location-independent execution of user interface operations comprises a tangible storage medium storing computer-readable instructions. In one instance, the instructions are operable to identify a user interaction through a client-side user interface that is communicably coupled with a server-side computer. The instructions then dynamically determine whether to process the identified user interaction on the client-side or the server-side. In some cases, the dynamic determination is made, at least in part, according to a plurality of criteria, including processing capability, number of roundtrips, and operating environment. And if the user interaction is to be processed on the client-side, the stored instructions invoke a client-side action handler, Otherwise, if the user interaction is to be processed on the server-side, the instructions request that a server-side action handler process the interaction.

Various embodiments may implement or utilize one or more of the following features. For example, the stored instructions may request that the server-side action handler process the interaction comprise by determining whether the user interaction involves a synchronous or asynchronous action and requesting that one of a synchronous server-side action handler or an asynchronous server-side action handler process the interaction based on the determination. In another example, the stored instructions may utilize a rules repository, or other similar logic, to determine whether to process the identified user interaction on the client-side or the server-side. This example rules repository can include a primary key that is, e.g. directly, mapped to the particular interaction or can include rules that store dynamic expressions of various interactions action. In yet another example, the stored instructions are further operable to receive the client-side action handler with user interface from the server-side computer. In situations where the user interaction involves multiple event cycles, the dynamic determination of whether to process the identified user interaction on the client-side or the server-side can occur for each event cycle.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system providing location-independent execution of user interface operations or interactions in accordance with one implementation of the present disclosure.

FIG. 2 is an example configuration of a wire described in FIG. 1.

FIG. 3 is an example instance of a wire described in FIG. 2.

FIG. 4 is an example wiring events cycle at runtime using the system described in FIG. 1.

FIG. 5 illustrates various usage cases of the system described in FIG. 1.

FIGS. 6A-C illustrate various example flows of the usage cases of FIG. 5 in accordance with one implementation of the present disclosure.

FIG. 7 illustrates an example wiring runtime sequence in accordance with one implementation of the present disclosure.

### DETAILED DESCRIPTION

An aspect of the present disclosure is directed to a system providing location-independent execution of user interface operations or interactions. More specifically, the system provides a framework for addressing the “client-side” vs. “server-side” question on a case by case manner. Put differently, there may be a need in an enterprise solution to control the origin of the request, particularly for external content. For example, a service provider may limit the access to the service from the customer machine or from the hosting environment. In another example, the solution may implement security such that external web content can be fetched from server side and not directly by the client browser (which may help control the size of data, filter out suspicious sites with a black list, etc.). The system may implement the server-side approach for most of the scenarios. Yet, in a particular runtime scenario, the system can implements mechanisms to execute a user-interaction on the client-side if this makes sense for this scenario or otherwise satisfies particular criteria. These criteria may include, among other things, determining if this improves the performance of the system or overall operation, if this saves roundtrips, or if this is not too complex to handle. In many cases, the decision as to which model to use to execute the interaction can be chosen by the framework transparently for the developer (i.e. the developer has not to decide whether to use a client-side or server-side approach). Depending on the running scenario/application, the framework dynamically decides which approach to implement. This could also depend on the environment the scenario/application is running (e.g., it could be a difference if an application is running within a portal). In short, the system does not enforce definitions beforehand (or in general), but instead provides the ability to implement case-by-case decisions and an optimized solution for a specific situation or scenario. As such, in certain configurations, this infrastructure may not be restricted to a client-side or server-side approach, may not be restricted to a certain system landscape, and may not be restricted to any specific UI technology.

One example is in the area of roundtrip optimizations. In this example, the user would like to trigger a navigation to another application. Depending on the scenario, this may be done via a direct client-side call (e.g. in simple scenarios, where the application can execute the operation as relatively standalone application) or via a server-roundtrip (e.g. in more complex scenarios, where the framework helps ensure consistency between other applications running on the same page before triggering the navigation). Instead of providing only one of the possibilities, the framework can provide one API to trigger the navigation, while overall the framework decides where to execute this navigation (i.e. on the client-side or on the server-side).

Another example is in the area of mashups (i.e. a composition of several small “applications” or “chips” that are connected via “wires” to have a simple communication) that include components or other technology from either server side or client side. To build a mashup, the “wiring” is typically done based on a event-based communication infrastructure. There can be pure client-side based mashup environments and there are server-based environments. Instead of defining the location of the processing of the interaction in a static way, the described framework can execute the operation according to different constraints. These example constraints can include: which type of applications are part of the mashup scenario and the current wiring? For example, the application can include only client-side, only server-based applications (with client front-end), or a combination. To help avoid undesired roundtrips, the framework may execute the user interaction on the client-side (e.g. if the user clicks on a control that changes some state in some other client-side app). Otherwise, the framework may determine that, e.g., i) the user interaction involves a too complex operation; ii) it is difficult to guarantee a consistent screen and, therefore, request that the operation done primarily on the server side; or iii) a mashup scenario with mixed runtime technologies (client side and server side) such that a combined event cycle is needed.

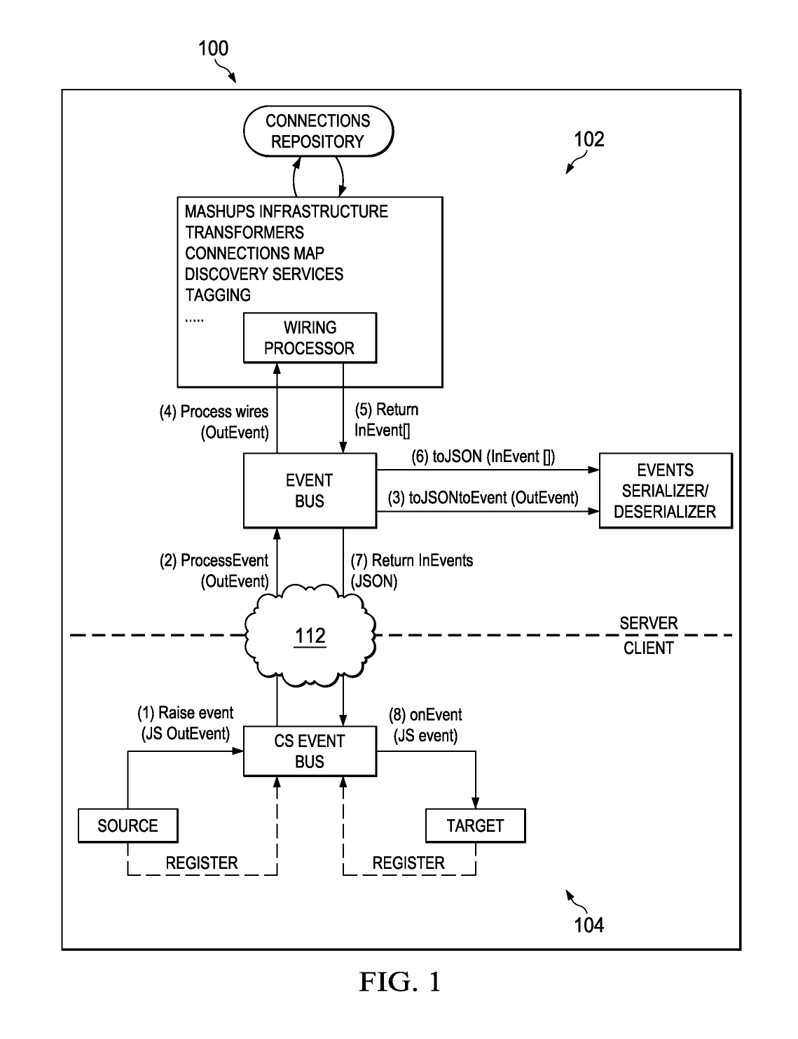

Turning to the illustrated embodiment, FIG. 1 illustrates an example system 100 that implements a landscape aware inter-application communication infrastructure. System 100 may be a distributed client/server system that spans one or more networks. In such implementations, data may be communicated or stored in an encrypted format using any standard or proprietary encryption algorithm. But system 100 may be in a dedicated enterprise environment—across a local area network or subnet—or any other suitable environment without departing from the scope of this disclosure. The system 100 may include or be communicably coupled with a server 102, one or more clients 104, and one or more networks 112.

The server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server that may be used with the disclosure, system 100 can be implemented using computers other than servers, as well as a server pool. Indeed, server may be any computer or processing device such as, for example, a blade server, general-purpose personal computer (PC), Macintosh, workstation, Unix-based computer, PDAs, smart phones in order to provide offline capabilities (small footprint server in the device), or any other suitable device. In other words, the present disclosure contemplates computers other than general purpose computers as well as computers without conventional operating systems. The server may be adapted to execute any operating system including Linux, UNIX, Windows Server, or any other suitable operating system. According to one embodiment, the server may also include or be communicably coupled with a web server and/or a mail server.

The server may include local memory. The memory is any tangible computer-readable memory that may include any memory or database module taking the form of volatile or non-volatile memory including, without limitation, magnetic media, optical media, random access memory (RAM), read-only memory (ROM), removable media, or any other suitable local or remote memory component. The memory may include, among other items, framework for location-independent execution of user interface operations or interactions and a plurality of applications, described in more detail below. Further, the memory may include one or more operating environments. The memory may also include other types of data, such as environment and/or application description data, application data for one or more applications, as well as data involving VPN applications or services, firewall policies, a security or access log, print or other reporting files, HyperText Markup Language (HTML) files or templates, related or unrelated software applications or sub-systems, and others. Consequently, the memory may also be considered a repository of data, such as a local data repository from one or more applications. Indeed, the location independent framework may reside both on server side and client side (client side logic and dispatching).

More specifically, the framework any application, program, module, process, or other software that is capable of using or facilitates usage of landscape aware inter-application communication infrastructure, which is itself software. Regardless of the particular implementation, “software” may include software, firmware, wired or programmed hardware, or any combination thereof embodied on tangible computer readable media. Indeed, form transformation module 130 may be written or described in any appropriate computer language including C, C++, Java, Visual Basic, assembler, Perl, any suitable version of 4GL, as well as others. For example, form transformation module 130 may be a composite application, portions of which may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET.

According to some implementations, the communications may be in the form of one or more eXtensible Markup Language (XML) documents files or portions or Structured Query Language (“SQL”) statements or scripts of a scripting language, a script language, or an extension language. For example, the communication structure 145 may be formatted, stored, or defined as various data structures in text files, Virtual Storage Access Method (VSAM) files, flat files, Btrieve files, comma-separated-value (CSV) files, internal variables, or one or more libraries. Aside from XML, other example scripting languages may include JavaScript, Cascading Style Sheets (CSS), HTML, asynchronous JavaScript and XML (AJAX), as well as others.

The server may also include processor. The processor executes instructions, such as the foregoing software, and manipulates data to perform the operations of the server and may be, for example, a central processing unit (CPU), a blade, an application specific integrated circuit (ASIC), or a field-programmable gate array (FPGA). It will be understood that multiple processors may be used according to particular needs and reference to a processor is meant to include multiple processors where applicable.

The network 112 facilitates wireless or wireline communication between computer the server and any other local or remote computer, such as clients 104. The network may be all or a portion of an enterprise or secured network. In another example, the network may be a VPN merely between the server and the client across wireline or wireless link. Such an example wireless link may be via 802.11a, 802.11b, 802.11g, 802.20, WiMax, and many others. While illustrated as a single or continuous network, the network may be logically divided into various sub-nets or virtual networks without departing from the scope of this disclosure, so long as at least a portion of the network may facilitate communications between the server and at least one client. For example, the server may be communicably coupled to a repository through one sub-net while communicably coupled to a particular the client through another. In other words, the network encompasses any internal or external network, networks, sub-network, or combination thereof operable to facilitate communications between various computing components in system 100. The network may communicate, for example, Internet Protocol (IP) packets, Frame Relay frames, Asynchronous Transfer Mode (ATM) cells, voice, video, data, and other suitable information between network addresses. The network may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, the network may be a secure network accessible to users via certain local or remote clients 104.

The client 104 may be any computing device operable to connect or communicate with the server or the network using any communication link. At a high level, each the client includes or executes at least a GUI and comprises an electronic computing device operable to receive, transmit, process and store any appropriate data associated with system 100. Moreover, the client includes a tangible memory and one or more processors. It will be understood that there may be any number of clients communicably coupled to server. Further, “client,” “local machine,” and “user” may be used interchangeably as appropriate without departing from the scope of this disclosure. Moreover, for ease of illustration, each the client is described in terms of being used by one user. But this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device. For example, the client may be a PDA operable to wirelessly connect with an external or unsecured network. In another example, the client may comprise a laptop computer that includes an input device, such as a keypad, touch screen, mouse, or other device that can accept information, and an output device that conveys information associated with the operation of the server or clients, including digital data, visual information, or GUI. Both the input device and output device may include fixed or removable storage media such as a magnetic computer disk, CD-ROM, or other suitable media to both receive input from and provide output to users of clients through the display, namely the client portion of GUIs or application interface.

The GUI can comprise a graphical user interface operable to allow the user of the client to interface with at least a portion of system 100 for any suitable purpose, such as viewing application or other transaction data. For example, the GUI could present various views on business information that are has been communicated between one or more applications or application instances, often via pages or containers. Generally, the GUI provides the particular user with an efficient and user-friendly presentation of data provided by or communicated within system 100. the GUI may comprise a plurality of customizable frames or views having interactive fields, pull-down lists, and buttons operated by the user. The GUI may also present a plurality of portals or dashboards. For example, the GUI may display a secure webpage that allows users to input and define search parameters for one or more modules. It should be understood that the term graphical user interface may be used in the singular or in the plural to describe one or more graphical user interfaces and each of the displays of a particular graphical user interface. Indeed, reference to the GUI may indicate a reference to the front-end or a component of application, as well as the particular interface accessible via the client, as appropriate, without departing from the scope of this disclosure. Therefore, the GUI contemplates any graphical user interface, such as a generic web browser or touch screen, that processes information in system 100 and efficiently presents the results to the user. The server can accept data from the client via the web browser (e.g., Microsoft Internet Explorer or Netscape Navigator) and return the appropriate HTML or XML responses to the browser using the network.

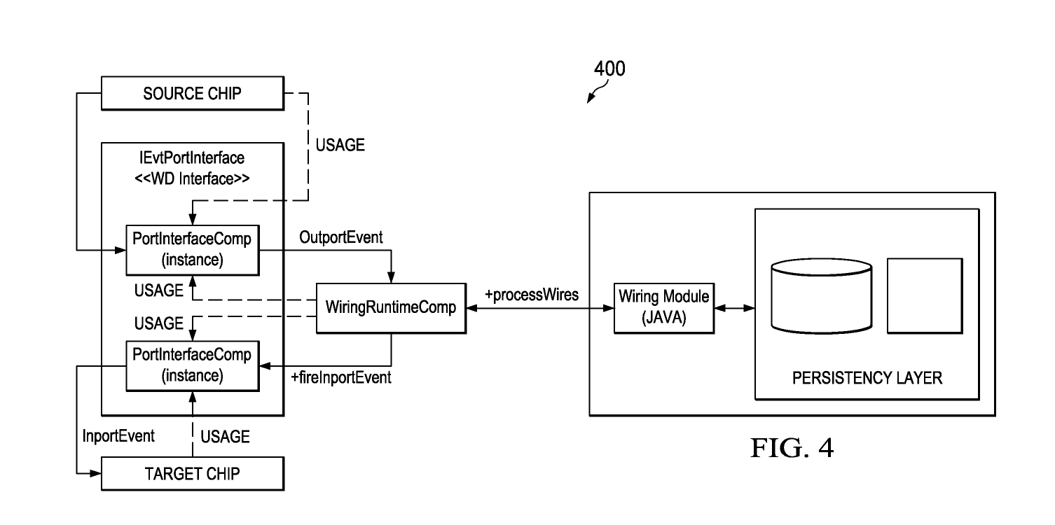

On the client side, there can be a client action dispatcher (CAD) or event bus or framework and application logic. In certain configurations, this is the single entry point for user interactions triggered by the user (e.g. by pressing a button, selecting a table row, and so forth). The CAD gets the action and analysis it using the rules engine. The rules engine can access the rules repository. The rules repository contains rules how “actions” should be processed. In the simplest case this is a simple mapping (e.g. “button click->server call”) but you could also image that the rules are dynamic expressions to decided how the action should be processed. The CAD can dispatch the action then to the needed action handler. More specifically, while wires information is usually stored in the server, the runtime processors (controllers) can be implemented either in client side and/or server side and responsible to mitigate between client side event cycles and server side events cycles. For example, FIG. 4 illustrates a server-side implementation. Returning to FIG. 1, the illustrated configuration describes a complementary client-side runtime component, which helps make the solution environment agnostic (meaning that it is able to handle both client side UI components and server side UI components in an event cycle).

Client side calls are handled directly by the client call action handler (or some other related module). For the server side call, the CAD (or some other related module) may differentiate between synchronous and asynchronous calls and, as such, may send the request to the appropriate synchronous and asynchronous handler. Also on the server side, there may be a specific application container running an application. For each channel, the application could then be called from the client-side via an server-side action handler (in the above example one for the synchronous calls and one for the asynchronous calls).

In one example of operation of a mashup configuration, as shown in example FIG. 1, a RaiseEvent call is identified by the client-side event bus from the source. The CAD triggers a ProcessEvent call to the server-side event bus, which calls an Events Serializer/Deserializer via fromJSONtoEvent. The server-side event bus contacts the mashup infrastructure (perhaps the wiring processor) via ProcessWires, which then invokes ReturnlnEvent. This event is then processed by the Events Serializer/Deserializer, via toJSON, and returned to the client-side event bus via ReturnInEvents. The CA then sends the event to the target via on Event.

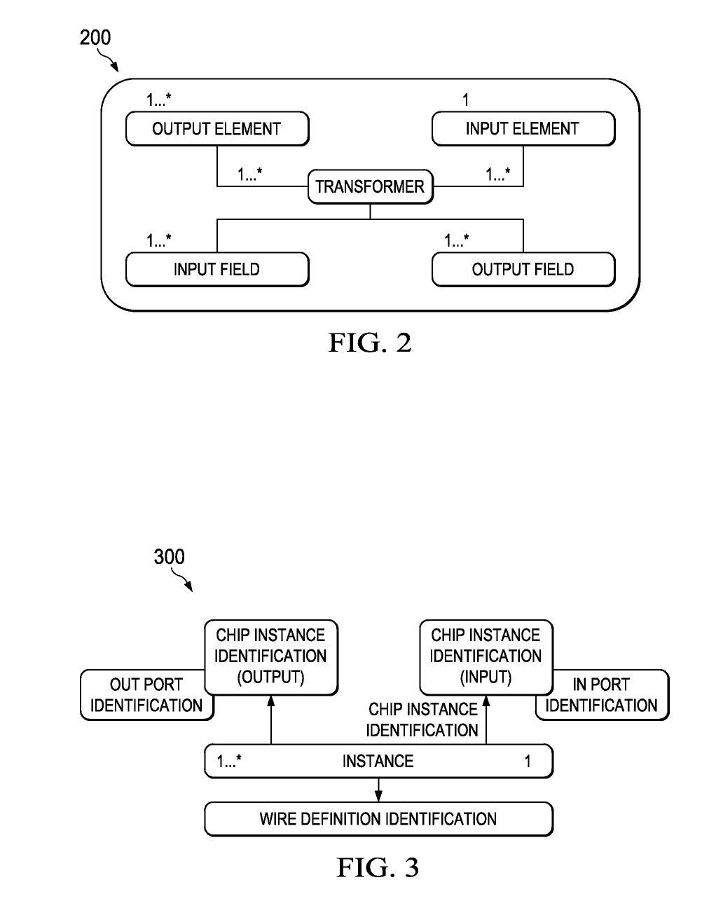

FIG. 2 is an example configuration 200 of a wire described in FIG. 1. The structure of the wiring definition object contains a transformer, which represents the actual wiring transformation data between sources and target chip definitions ports. In other words, transformers help enable communication for substantially incompatible components to communicate with each other and exchange information. Transformers may translate information according to definitions implemented within a particular object class. To ease processing, simple transformation may be done on client-side, but more complex transformation with business logic (service calls) may be done on server side. As such, a hybrid solution can enable this mixed flow of data. In this example, the wire definition 200 also includes one or more output elements, an input element, one or more input fields, and one or more output fields. In some situations, the wiring persistency can be optimized for runtime, runtime authoring and admin scenarios. In runtime processes, the out events from source is transformed into in events to a target. The wiring data is transported, and can be associated with a container (workspace/page) such that its lifecycle can be managed with the container's lifecycle. It will be understood that this is an abstract illustration of a wire, such that there is a derived client-side based representation of it (JavaScript based) and derived server-side based representation of it (Java based). These two co-exist and share the same definitions. This configuration helps enable running a client side events scenario and server side events scenario based on the same metadata while activating the respective transformer and event handlers according to the environment.

The wire definitions can be stored in a global repository (or other persistency) and represent wire that have been created on the system. In some cases, these definitions can be accessed by various wiring instances in the differing systems. When a new instance is added, wire definitions can be searched by suggestion mechanism.

FIG. 3 is an example instance 300 of a wire described in FIG. 2. This instance 300 maps source chip instance's out-ports, and a target chip instance's in-port, to a particular wire definition. In some configurations, the instance is associated with a particular container (page/workspace) and it helps provide fast access to a corresponding wire definition in runtime. As noted above, the life cycle of a wiring instance is often related to the container. For example, when the page is deleted/copied/transported the wired instances of the page should typically be handled the same way. To help accomplish this, one implementation may be to store wire instances locally under the page, as XML representation in an attribute. An example of this implementation may be as follows:

```
<wiring>
  <target id=““ port=““ wireDefinitionId=““>
      <src id=““ port=““/>
      <src id=““ port=““/>
      ..
  </target>
      ..
</wiring>
```

In this example, the wiring map will be resolved at runtime to a dedicated data structure in memory, which will provide fast access to the relevant wiring data. Of course, this example implementation is for illustration purposes only and any language, format, or other implementation details may be utilized as appropriate.

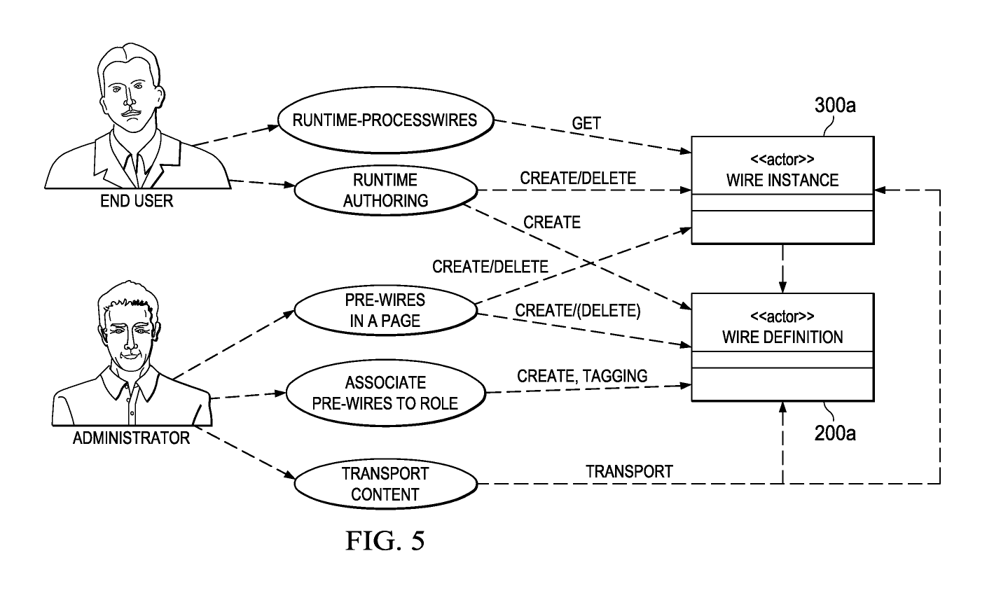

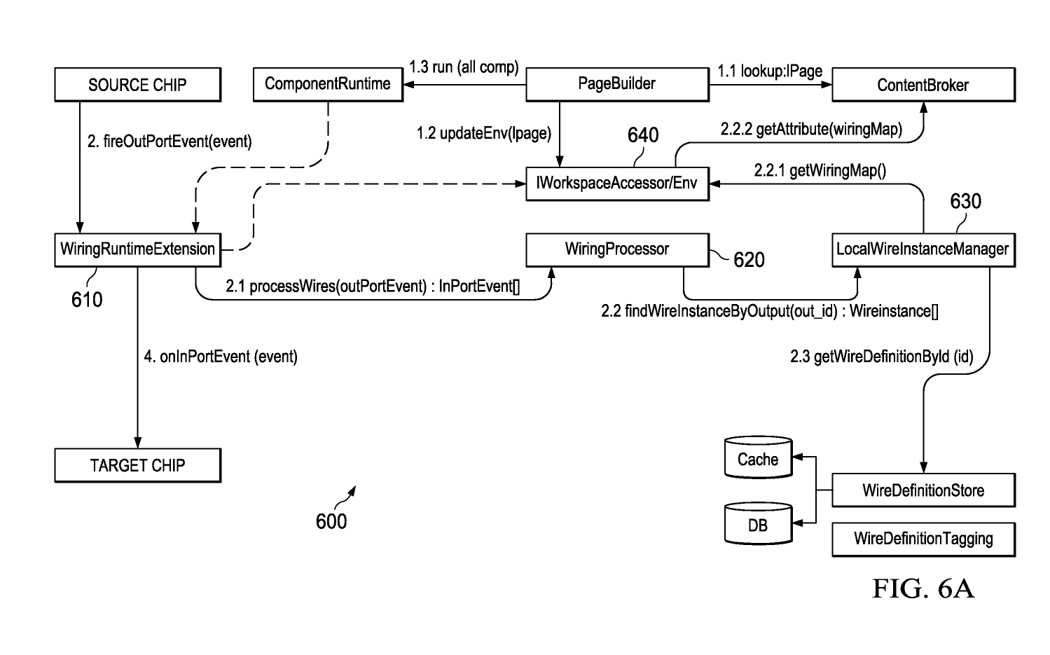

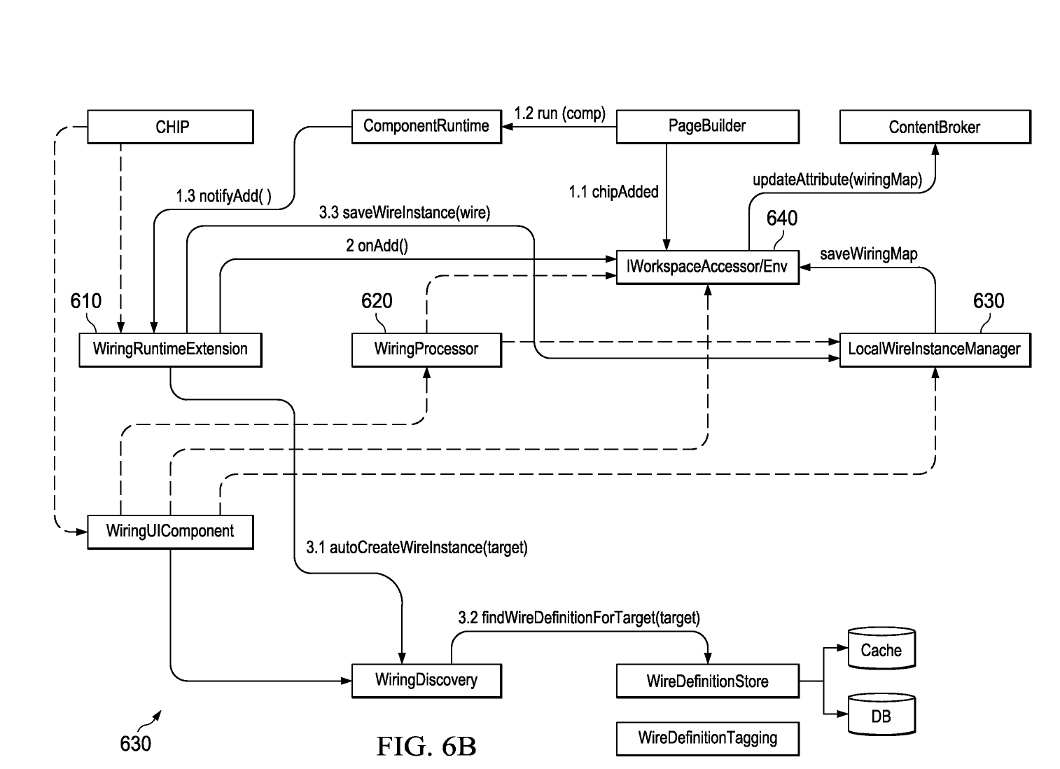

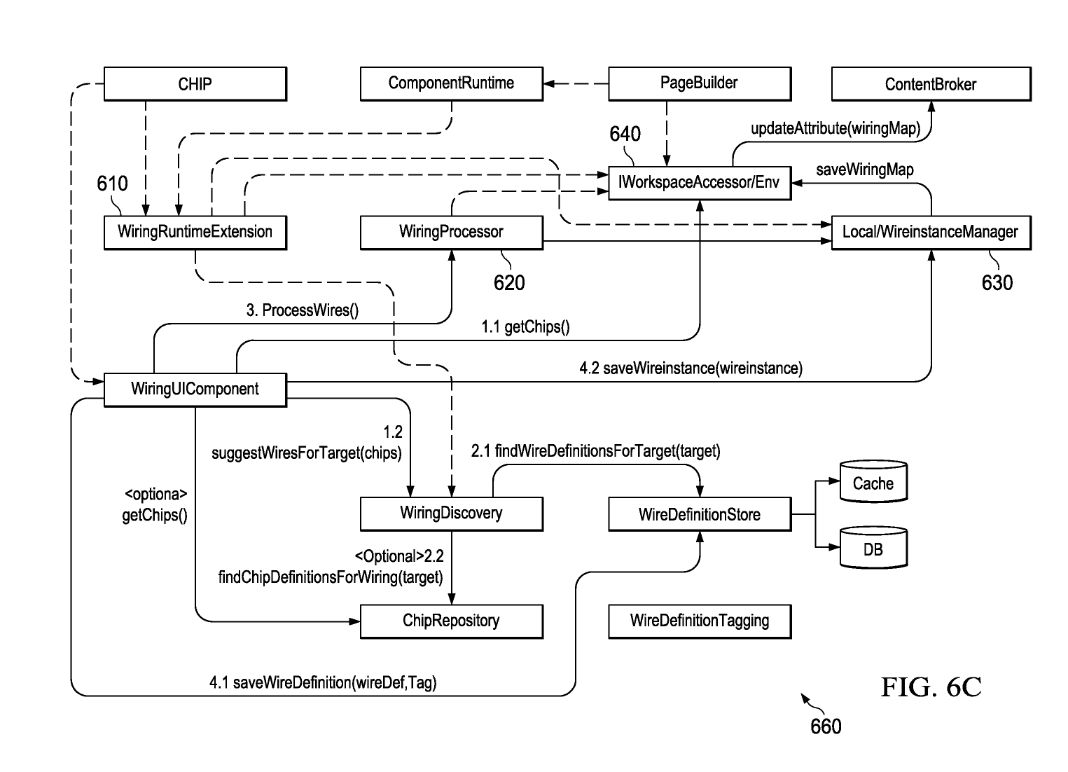

FIG. 5 illustrates various usage cases of the system described in FIG. 1. At a high level, the illustration depicts three usage cases: runtime, runtime authoring, and administration, each of which is described in more detail in FIG. 6. Specifically, FIG. 6A illustrates example components and data flow 600 to implement run time processing of wires, FIG. 6B illustrates example components and data flow 630 to implement run time authoring of wires, and FIG. 6C illustrates example components and data flow 660 to implement administration of wires.

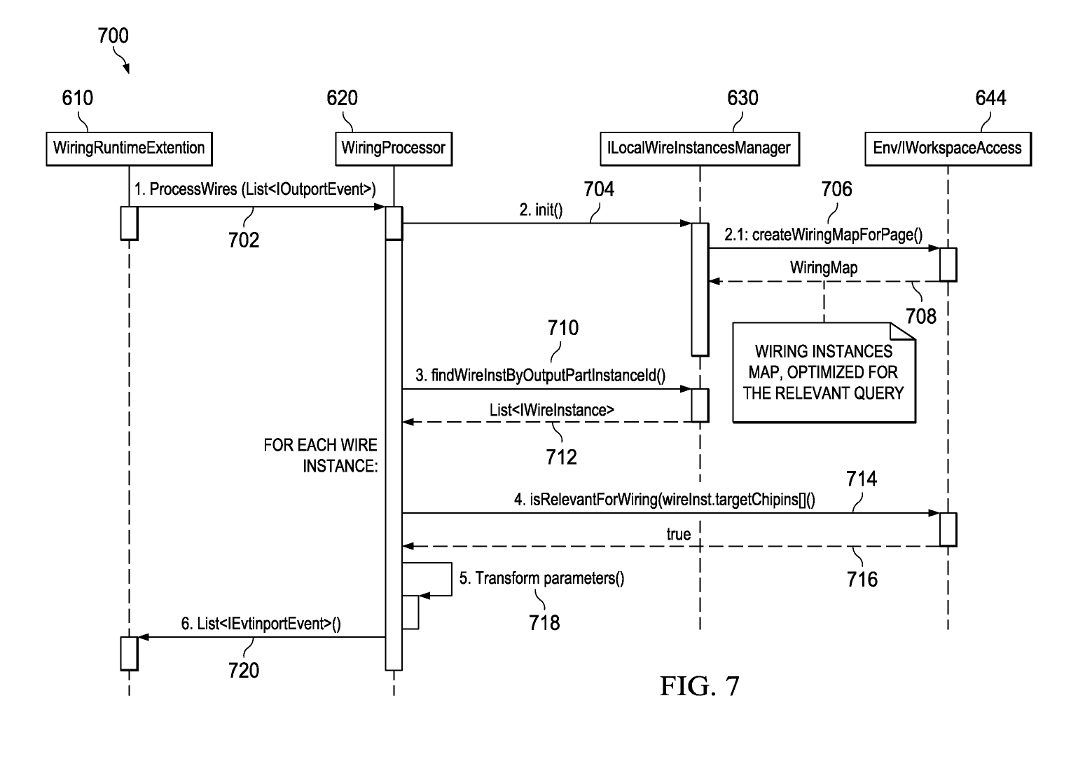

FIG. 7 illustrates an example wiring runtime sequence 700 in accordance with one implementation of the present disclosure, such as data flow 600. For clarity of presentation, the description that follows generally describes method 700 in the context of environment illustrated in FIG. 1. However, it will be understood that the method 700 may alternatively be performed by any other suitable system, environment, or combination of systems and environments as appropriate.

Specifically, runtime sequence 700 illustrates that the WiringRuntimeExtension 610 calls the WiringProcessor 620 via a ProcessWires method at 702. The WiringProcessor then invokes the iLocalWireInstanceManager 630, perhaps via an init( ) method call at 704. The Environment or Workspace access module 640 is invoked via a createWiringMapForPage( ) at 706, which generates and returns the WiringMap at 708. The WiringProcessor determines the wiring instances 300 by contacting the iLocalWireInstanceManager module at step 710, which are returned at step 712. These instances may be returned as any appropriate communication or data structure, such as an array, objects, or a list. The WiringProcessor then contacts the Environment or Workspace access module to determine if each particular wiring instance is relevant for this particular action at 714 and 716. The WiringProcessor then transforms the parameters at step 718 and returns the inport events at 720.

While the present disclosure uses a plurality of data and processing flows and accompanying descriptions to illustrate the example techniques associated with the various disclosed methods and techniques, system 100 contemplates using or implementing any suitable technique for performing these and other tasks. It will be understood that these techniques are for illustration purposes only and that the described or similar techniques may be performed at any appropriate time, including concurrently, individually, or in combination. In addition, many of the steps in these flows may take place simultaneously and/or in different orders than as shown and described. Moreover, system 100 may use processes and methods with additional, fewer, and/or different steps, so long as the processes and methods remain appropriate. In short, although this disclosure has been described in terms of certain implementations and generally associated methods, alterations and permutations of these implementations and methods will be apparent to those skilled in the art. Accordingly, other implementations are within the scope of the following claims.

What is claimed is:

1. A computer-implemented method for location-independent execution of user interface operations, the method comprising the following steps executed by one or more processors:
identifying a user interaction through a client-side user interface that is communicably coupled with a server-side computer;
dynamically determining whether to process the identified user interaction on the client-side or the server-side;
if the user interaction is to be processed on the client-side, invoking a client-side action handler; and
if the user interaction is to be processed on the server-side, requesting that a server-side action handler process the interaction.

2. The computer implemented method of claim 1, where requesting that a server-side action handler process the interaction comprises:
determining whether the user interaction involves a synchronous or asynchronous action; and
requesting that one of a synchronous server-side action handler or an asynchronous server-side action handler process the interaction based on the determination.

3. The computer implemented method of claim 1, where dynamically determining whether to process the identified user interaction on the client-side or the server-side comprises utilizing a rules repository to determine whether to process the identified user interaction on the client-side or the server-side.

4. The computer implemented method of claim 3, where the rules repository includes a primary key that is mapped to the particular interaction.

5. The computer implemented method of claim 3, where the rules repository includes rules that store dynamic expressions of various interactions action.

6. The computer implemented method of claim 1, further comprising receiving the client-side action handler with user interface code from the server-side computer.

7. The computer implemented method of claim 1, the dynamic determination made, at least in part, according to a plurality of criteria, including processing capability, number of roundtrips, and operating environment.

8. A computer program product for location-independent execution of user interface operations, the computer program product comprising a tangible storage medium storing computer-readable instructions operable when executed to:
identify a user interaction through a client-side user interface that is communicably coupled with a server-side computer;
dynamically determine whether to process the identified user interaction on the client-side or the server-side;
if the user interaction is to be processed on the client-side, invoke a client-side action handler; and
if the user interaction is to be processed on the server-side, request that a server-side action handler process the interaction.

9. The computer program product of claim 8, where the stored instructions requesting that a server-side action handler process the interaction comprise stored instructions:
determining whether the user interaction involves a synchronous or asynchronous action; and
requesting that one of a synchronous server-side action handler or an asynchronous server-side action handler process the interaction based on the determination.

10. The computer program product of claim 8, where dynamically determining whether to process the identified user interaction on the client-side or the server-side comprises utilizing a rules repository to determine whether to process the identified user interaction on the client-side or the server-side.

11. The computer program product of claim 10, where the rules repository includes a primary key that is mapped to the particular interaction.

12. The computer program product of claim 10, where the rules repository includes rules that store dynamic expressions of various interactions action.

13. The computer program product of claim 8, where the stored instructions are further operable to receive the client-side action handler with user interface code from the server-side computer.

14. The computer program product of claim 8, the dynamic determination made, at least in part, according to a plurality of criteria, including processing capability, number of roundtrips, and operating environment.

15. The computer program product of claim 8, where the dynamic determination of whether to process the identified user interaction on the client-side or the server-side occurs for each event cycle where the user interaction involves multiple event cycles.

16. A computer system for communicating via a landscape aware inter-application communication infrastructure, the computer system comprising:
memory storing a client-side user interface and a client-side action handle; and
one or more processors that, when executed:
identify a user interaction through the client-side user interface that is communicably coupled with a server-side computer;
dynamically determine whether to process the identified user interaction on the client-side or the server-side;
if the user interaction is to be processed on the client-side, invoke the client-side action handler; and
if the user interaction is to be processed on the server-side, request that a server-side action handler process the interaction.

17. The computer system of claim 16, where the one or more processors requesting that a server-side action handler process the interaction comprises the one or more processors:
determining whether the user interaction involves a synchronous or asynchronous action; and
requesting that one of a synchronous server-side action handler or an asynchronous server-side action handler process the interaction based on the determination.

18. The computer system of claim 16, where the memory further stores a rules repository and where the one or more processors dynamically determine whether to process the identified user interaction on the client-side or the server-side by utilizing the rules repository.

19. The computer system of claim 18, where the rules repository includes a primary key that is mapped to the particular interaction.

20. The computer system of claim 18, where the rules repository includes rules that store dynamic expressions of various interactions action.

21. The computer system of claim 18, the one or more processors further operable to receive the client-side action handler with user interface code from the server-side computer.
